(19) United States
(12) Patent Application Publication
(10) Pub. No.: US 2009/0160281 A1
(43) Pub. Date: Jun. 25, 2009

(54) PERMANENT MAGNET MOTOR WITH RADIALLY SUPPORTED SLEEVE

(76) Inventors: Roy D. Rasmussen, Rockford, IL (US); Craig R. Legros, Rockford, IL (US)

Correspondence Address: CARLSON, GASKEY & OLDS, P.C., 400 WEST MAPLE ROAD, SUITE 350, BIRMINGHAM, MI, 48009, US

(21) Appl. No.: 11/961,081

(22) Filed: Dec. 20, 2007

(51) Int. Cl. H02K 1/28; H02K 1/27; H02K 1/30

(52) U.S. Cl. 310/156.12; 310/156.28

(57) ABSTRACT

A rotor assembly includes several permanent magnets separated by spacers. The permanent magnets and the spacers are all fabricated from material having the same coefficient of thermal expansion. The spacers are in a non-magnetized state and provide support for a sleeve placed in a high interference fit with the permanent magnets. The sleeve is thereby fully supported about the inner circumference such that uneven bending stresses are significantly reduced to provide a desired operational life.

### BACKGROUND OF THE INVENTION

This invention generally relates to an electric motor. More particularly, this invention relates to a rotor and method of fabricating a rotor for an electric motor.

Conventional permanent magnet electric motors include a rotor assembly having pole permanent magnets bonded to a rotor hub and contained within a non-magnetic metal sleeve. Conventional rotor assemblies have included a non-magnetic material such as for example plastic between each of the permanent magnets to maintain a desired orientation of the permanent magnets on the rotor hub. An interference fit between the metal sleeve and permanent magnets holds the permanent magnets tightly against the rotor.

In conventional rotor assemblies, the metal sleeve remains unsupported by the underlying permanent magnets in areas and air gaps between adjacent permanent magnets. The plastic material does not provide desired support of the metal sleeve. These unsupported regions generate bending stresses caused by cyclical centrifugal forces produced during operation. The bending stresses result from an initial cording of the sleeve between adjacent permanent magnets across an unsupported region. The cording results in a flat spot between each of the permanent magnets. The unsupported flat spot expands outwardly in response to centrifugal forces produced during high speed rotation. This fluctuating movement between the corded condition and the expanded condition creates fatigue stresses in the metal sleeve that reduce operational life. Further, dissimilar materials between the permanent magnets generate non-uniform thermal expansion against the sleeve also creating unbalanced stresses on the metal sleeve.

A conventional solution for improving rotor assembly life is to use exotic and relatively expensive grades of metal for the metal sleeve with higher fatigue strength. Such expensive grades of material are prohibitively expensive and are difficult to manufacture and assemble.

Accordingly, it is desirable to design and develop a rotor that does not require expensive materials to provide a desired operational life.

### SUMMARY OF THE INVENTION

A disclosed example electric motor assembly includes a rotor assembly that includes a sleeve holding pole magnets to a rotor hub and a spacer between each of the pole magnets that is made of the same material as the pole magnets in a non-magnetized state.

The example rotor assembly includes a sleeve that is placed in a high interference fit with permanent magnets supported on the hub. The interference fit provides a desired pressure between the hub and the permanent magnets. A spacer disposed between each of the example permanent magnets is comprised of the same material as the permanent magnets, only in a non-magnetized state. The sleeve is also in an interference fit with the spacers such that the spacers provide radial support of the sleeve in the spaces between the permanent magnets.

Accordingly, the example rotor assembly provides for the use of common materials for a rotor assembly.

These and other features of the present invention can be best understood from the following specification and drawings, of which the following is a brief description.

### BRIEF DESCRIPTION OF THE DRAWINGS

FIG. 1 is a cross-sectional view of an example electric motor including the example rotor.

FIG. 2 is a perspective view of the example rotor assembly

FIG. 3 is an exploded view of the example rotor assembly with the sleeve removed from about the permanent magnets.

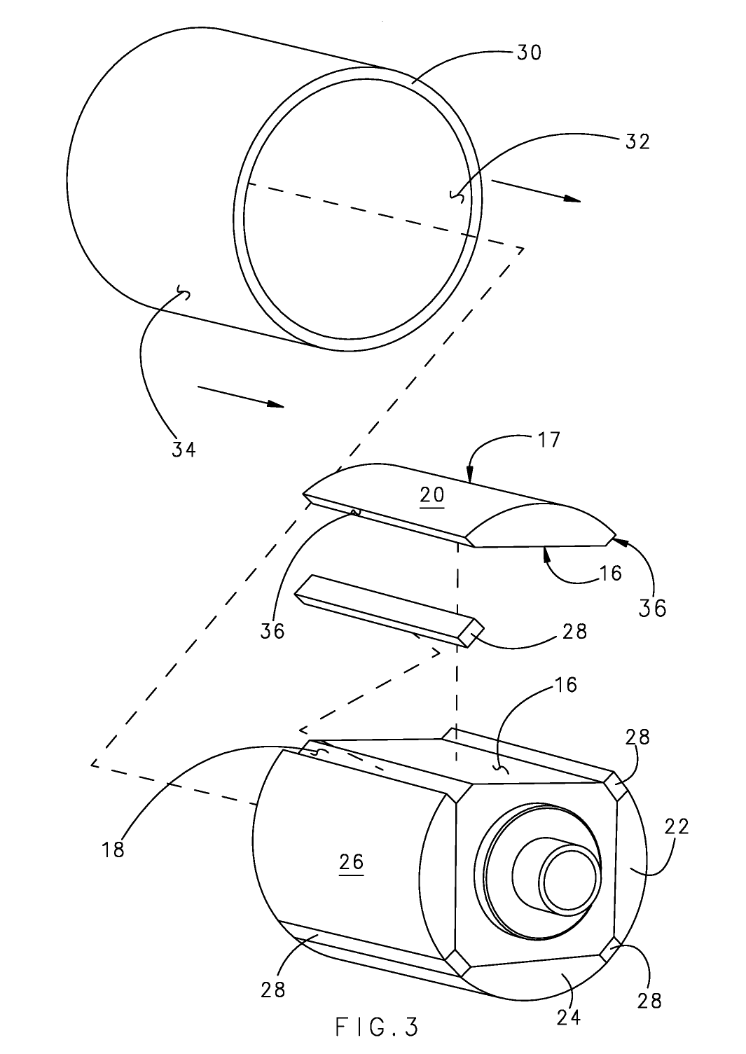

### DETAILED DESCRIPTION OF THE PREFERRED EMBODIMENT

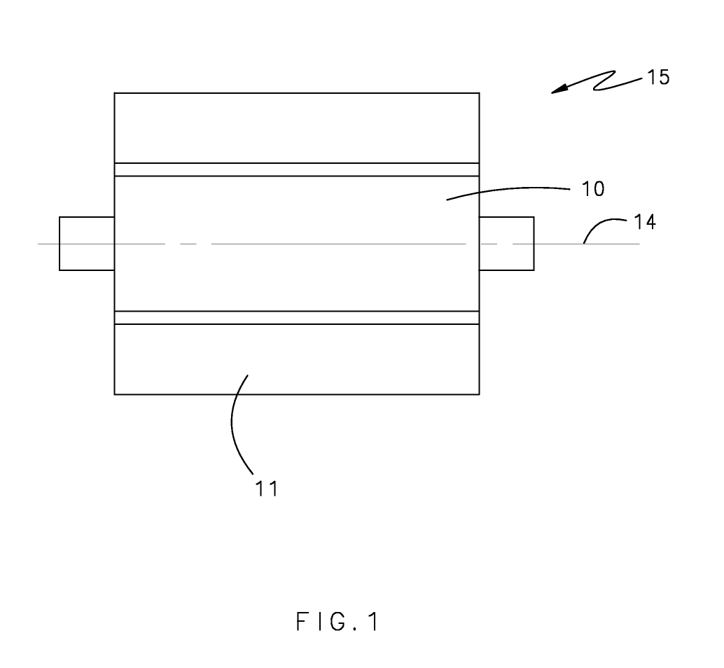

Referring to FIG. 1, an example electric motor assembly 15 includes a stator 11 and a rotor assembly 10 that rotates about an axis 14 relative to the stator 11.

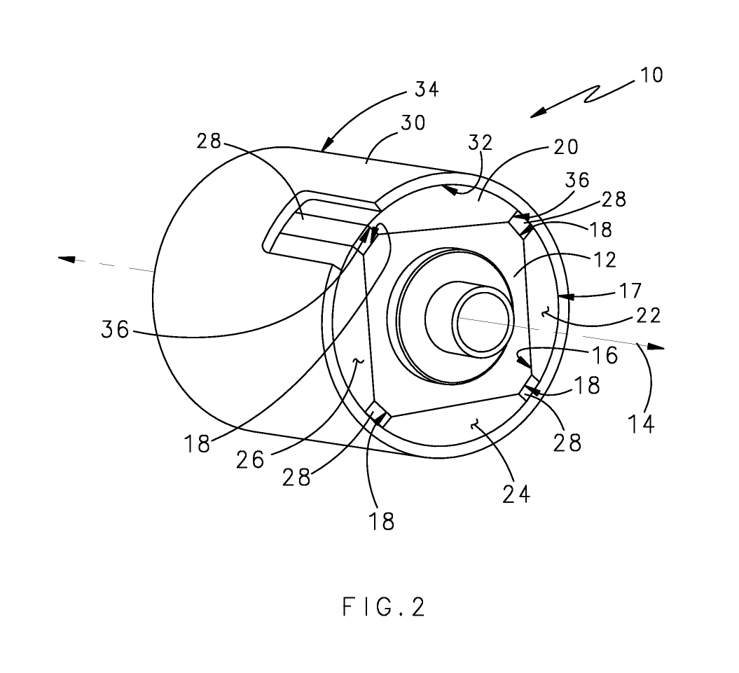

Referring to FIG. 2, the rotor assembly 10 includes a rotor hub 12 that supports permanent magnets 20, 22, 24, 26. The permanent magnets 20, 22, 24, 26 are supported on the rotor hub 12 and contained within a non-magnetic metal sleeve 30. The non-magnetic metal sleeve 30 is installed over the permanent magnets 20, 22, 24 and 26 in a high interference fit to maintain a desired contact pressure between the magnets 20, 22, 24 and 26 and the rotor hub 12. High contact pressure is used to provide desired torque production from the electric motor assembly 15

Spacers 28 are disposed between each of the permanent magnets 20, 22, 24 and 26. The spacers 28 are comprised of the same material used for the permanent magnets 20, 22, 24, 26 except in a non-magnetic state. Because the permanent magnets 20, 22, 24, 26 and spacers 28 are fabricated from the same material, they each have the same coefficient of thermal expansion. Therefore, the permanent magnets 20, 22, 24, 26 and the spacers 28 expand at the same rate and any expansion caused by heating of the magnets 20, 22, 24, 26 and spacers 28 results in a pressure uniform about the inner circumference of the sleeve 30. Because the metal sleeve 30 is supported along the entire inner surface 32, non-uniform stresses are substantially eliminated and increase the operational life of the metal sleeve 30.

Each of the permanent magnets 20, 22, 24, 26 includes a flat surface 16 that fits to the rotor hub 12 and a radially curved surface 17 that corresponds to the internal radius of the metal sleeve 30. Sides 36 of each of the permanent magnets 20, 22, 24, 26 are disposed adjacent each of the spacer 28. The example sides 36 comprise a surface that is transverse to the inner surface 32 of the metal sleeve 30.

The rotor 12 includes a corresponding chamfered surface 18 on which the spacers 28 are supported. The spacers 28 are substantially a rectangular shaped block that extends the axial length of the sleeve 30. The width of the spacer 28 matches the width of the chamfered surface 18 of the rotor hub 12. The chamfered sides 36 of the permanent magnets 20, 22, 24, 26 and the rotor hub 12 both simplify construction of the spacer 28 and provide the desired magnetic flux path between magnets 20, 22, 24, 26.

The example permanent magnets 20, 22, 24, 26 are fabricated from a Samarian cobalt material that is magnetized utilizing known techniques and processes. The spacers 18 are also fabricated from the Samarian cobalt material except they are not in a magnetized state. The Samarian cobalt material is only one material that may be used within the contemplation of this invention. Other known magnetic material could also be used for the permanent magnets 20, 22, 24, 26 and the spacers 28. Further, the example materials used for the permanent magnets 20, 22, 24, 26 and the spacers 28 include the same coefficient of thermal expansion. Accordingly, two or more different materials with the same substantially similar coefficients of thermal expansion could also be used for the spacers and permanent magnets.

The sleeve 30 is fabricated from a non-magnetic material such as for example Inconel 718 or other non-magnetic metal materials. Other materials commonly used for fabrication of a rotor assembly may also be used for fabrication of the metal sleeve.

Accordingly the disclosed rotor assembly 10 supports substantially the entire inner circumference 32 of the metal sleeve 30 to greatly reduce bending stresses caused by unsupported sections during operation and therefore does not require expensive and difficult to obtain materials. Further the spacers 28 are fabricated from a material that is the same as, or has a substantially similar coefficient of thermal expansion as, the material that comprises the permanent magnets such that any thermal expansion occurs uniformly over the entire inner circumference of the metal sleeve.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. An electric motor assembly comprising:
a stator; and
a rotor rotatable relative to the stator including a rotor hub, a plurality of pole magnets, a sleeve disposed about the plurality of pole magnets, and a spacer disposed between each of the plurality of pole magnets, wherein each spacer comprises a material that is the same as material comprising the plurality of pole magnets and wherein the spacer material is in a non-magnetized state.

2. The assembly as recited in claim 1, wherein the sleeve comprises a non-magnetic metal material.

3. The assembly as recited in claim 1, wherein a fit between the sleeve and the plurality of pole magnets comprises a high interference fit.

4. The assembly as recited in claim 3, wherein the fit between the spacers and the sleeve comprises a high interference fit.

5. The assembly as recited in claim 1, wherein the spacers and the plurality of pole magnets support the sleeve's entire inner circumference.

6. The assembly as recited in claim 1, wherein each of the plurality of pole magnets includes a chamfered end adjacent one of the spacers.

7. The assembly as recited in claim 1, wherein the rotor includes at least four corners that comprise a chamfer, and the spacers are disposed between the chamfer of the rotor and the sleeve.

8. The assembly as recited in claim 1, wherein the spacers comprises material identical to the material comprising the plurality of permanent magnets.

9. A rotor assembly for an electric motor comprising:
a rotor hub rotatable about an axis and including at least four sides;
a plurality of permanent magnets disposed on each of the at least four sides;
a sleeve comprising non-magnetic steel pressed over the plurality of permanent magnets; and
a spacer between each of the plurality of permanent magnets comprising a material common to the plurality of permanent magnets.

10. The assembly as recited in claim 9, wherein the rotor hub includes a chamfered surface between each of the at least four sides, and the spacer is disposed between the chamfered surface and the sleeve.

11. The assembly as recited in claim 9, wherein each of the plurality of permanent magnets includes a chamfered surface adjacent the spacer.

12. The assembly as recited in claim 9, wherein an interface between the sleeve, the plurality of permanent magnets and the spacer is a high interference fit.

13. The assembly as recited in claim 9, wherein the sleeve is radially supported about its entire inner circumference by the plurality of permanent magnets and spacers disposed between each of the plurality of permanent magnets.

14. The assembly as recited in claim 9, wherein the spacer comprises a material with a coefficient of thermal expansion that is substantially similar to the coefficient of thermal expansion of the material comprising each of the plurality of permanent magnets.

15. The assembly as recited in claim 9, wherein the plurality of permanent magnets and the spacer disposed between each of the plurality of permanent magnets are of an axial length at least as long as the sleeve.
